(19) United States
(12) Patent Application Publication
(10) Pub. No.: US 2011/0079129 A1
(43) Pub. Date: Apr. 7, 2011

(54) VARIABLE WINDOW POSITION IN FLEX DIE CUTTER

(76) Inventors: Siegfried FUCHS, Bendorf (DE); Michael Closmann, Raubach (DE); Harald Schumann, Neuwied (DE)

(21) Appl. No.: 12/897,215

(22) Filed: Oct. 4, 2010

Related U.S. Application Data
(63) Continuation of application No. PCT/EP2009/003767, filed on May 27, 2009.

(30) Foreign Application Priority Data
May 29, 2008 (DE) DE 102008025899.7

(51) Int. Cl. B26D 7/26

(52) U.S. Cl. 83/698.21

(57) ABSTRACT

A film cutter arrangement for a cutter roller is provided, and punched film cutters for producing cutouts have a cutting edge. The film cutter arrangement and the punched film cutters are attached to a lateral surface of the cutter roller magnetically and/or by vacuum. The punched film cutters can be variably positioned relative to the format film cutters in axial and circumferential directions of the cutter roller by adapter elements.

This nonprovisional application is a continuation of International Application No. PCT/EP2009/003767, which was filed on May 27, 2009, and which claims priority to German Patent Application No. DE 10 2008 025 899.7, which was filed in Germany on May 29, 2008, and which are both herein incorporated by reference.

### BACKGROUND OF THE INVENTION

1. Field of the Invention

Flex die cutters with fixed window positions and flex die cutters with variable window positions are used in production machines, in particular production machines that are used for manufacturing mailing envelopes of all formats with cut-out windows. Depending on the format of, for instance, a mailing envelope, windows are cut in a wide variety of positions by the flex die cutters, which project above the lateral surface of a cylinder.

2. Description of the Background Art

An interchangeable flex die cutter is known from U.S. Pat. No. 6,766,733 B1. The flex die cutter disclosed therein is one with which a variable window position may be produced. The variability in the location of the window position relates only to the axial direction, however. In the solution known from U.S. Pat. No. 6,766,733 B1, a window cutout for cutting a window in a planar sheet of material, such as a sheet of paper for instance, is affixed in different positions in the axial direction using attachment pins. This means that the window cutout can be cut in changeable positions in the axial direction with respect to the mailing envelope being produced.

DE 199 25 612 A1, which corresponds to U.S. Pat. No. 6,494,123, and which is incorporated herein by reference, relates to a rotary blade roll. It is preferably used for manufacturing envelope blanks. The rotary blade roll includes at least one roll body part that is located in a rotationally fixed manner on a rotating shaft and on whose circumferential surface magnetic elements are arranged in rows, wherein at least one flex die cutter is provided which has a thin, flexible base plate made of a magnetically permeable material, from which projects at least one sharp cutting edge designed as a single piece. This cutting edge is designed with a predetermined cutting shape, wherein the base plate has front and back edges and two opposing side edges, and the flex die cutter is held by means of the magnetic elements such that it lies flat on the circumferential surface.

Holding and positioning pins are arranged in a row in the roll body part. These pins project radially out of the circumferential surface to a height h, which corresponds approximately to a thickness d₁ of the base plate, wherein a number of slots oriented toward the cutting edge are made in a row in the base plate in a region adjoining the forward edge; the width b of these slots corresponds to a width b₁ of the holding and positioning pins. These pins project into the slots so that the flex die cutter can be axially displaced and repositioned in the region of a slot length, but is positioned in a fixed and reproducible manner viewed in the circumferential direction of the second body part.

Both of the solutions outlined above according to U.S. Pat. No. 6,766,733 B1 and DE 199 25 612 A1 are solutions in which the flex die cutters disclosed in each case have a fixed, predetermined arrangement with respect to the window position they are to produce. An entire new window cutter is needed for each change in contour or position of the window. Even in the case of flex die shape cutters in which axial adjustment is possible, a new flex die window cutter is needed for a radial change in position. Moreover, it is worth noting that separate cutting stations are normally required for shape cutting and for window cutting.

### SUMMARY OF THE INVENTION

It is therefore an object of the present invention to permit flexibility during cutting of envelopes of different designs with flex die cutters on just one magnetic cylinder, in particular in the positioning of the window to be cut out.

It is proposed according to an embodiment of the invention to change the window position in which an envelope window is to be cut in both the axial and radial (x- and y-) directions in a certain format during shape cutting. To this end, displaceable flex die window cutters are attached, which is accomplished using a pin strip principle. This means that existing flex die window cutters that are already employed which have suitable openings for the attachment pins may be used.

Depending on the design of the die shape cutter employed, the pin strip of the magnetic roll is used, or pins on the flex die shape cutter are used.

The placement of the flex die window cutter can take place within a recess of the flex die shape cutter. The recess is located, for example, in the region of the shape level in nearly the entire blank region when the outline cutters can be positioned only on die shape cutters implemented as side strips.

The variability in axial window positions is provided by the consistent use of the pin strip principle. The variability in the radial window position is achieved by means of prefabricated adapter plates. These adapter plates are aligned either by means of the aforementioned pin strip principle, or by placement at a bottom recess edge of the flex die shape cutter.

A grid of radial positions can be covered by the adapter plates. Additional radial positions can be achieved by shortening the adapter plates.

The cylinders on production machines in which all formats of envelopes, for example, can be produced, are implemented as magnetic cylinders, which is to say they have permanent magnet characteristics. These magnetic characteristics of the lateral surface of the cylinder permit the securing of flex die shape cutters and flex die window cutters with the assistance of magnetic force. Generally, the flex die shape cutters and the flex die window cutters that assume variable axial and radial positions on the lateral surface are subjected to vacuum in order to secure them reliably to the lateral surface. To this end, the entire lateral surface of a cylinder is perforated with a plurality of holes, of which a number of perforations extend, e.g., in the form of rows and segments to the lateral surface of the cylinder. If individual segments are subjected to vacuum, then the flex die shape cutters or the flex die window cutters are held in their predetermined position on the circumference of the cylinder, so that centrifugal forces that arise at high rotational speeds can be counteracted, which is to say that both the flex die shape cutters and the flex die window cutters are held reliably on the circumference of the cylinder. The flex die shape cutters and flex die window cutters are held on the circumference of the cylinder primarily by magnetic force. The application of vacuum to the blade roll tends to have more of a supporting effect with regard to securing the flex die shape cutter and the flex die window cutter or cutters employed. As a result of the application of vacuum to the blade roll, envelopes, for example, are held during transport, and as a result of suction ports subjected to vacuum, the scraps of paper produced during cutting of the envelopes are held and secured by the ports subjected to vacuum, and are later removed from the transport path.

In accordance with an embodiment of the invention, the flex die window cutters can be attached at existing pin strips of the flex die shape cutters employed. Direct attachment of a flex die window cutter on an appropriate pin strip, for example on an inside edge of a flex die shape cutter, can be carried out; in addition, the use of adapters or embossing plates of different widths and with greater lengths in the circumferential direction is also possible, so that the flex die window cutter can be secured in any desired axial or circumferential direction within a cutout region of a flex die shape cutter. Apart from adapter plates implemented in different configurations, the flex die window cutter can also be secured in addition by adapter strips on the circumference of the cylinder. The adapter strips can be attached to the lateral surface of the cylinder both magnetically and through the application of vacuum. The application of vacuum is recommended especially at relatively high rotational speeds, which is to say high production speeds, on account of the high centrifugal forces produced during operation.

In addition to direct alignment of the flex die window cutter used in each case, the adapter plates that are used can likewise be aligned by means of the pin strip principle or they can be fixed in their position by placement on one of the recess edges of flex die shape cutter. Because of the different configuration of the adapter plates, which can be implemented, for example, as embossing or adapter plates in the shape of cuboids or strips, it is possible to achieve all common window positions to be produced in all common formats of envelopes within one recess in a flex die shape cutter.

A set of adapter strips or adapter plates can be used, so that the flex die window cutters can be repositioned easily and quickly to the new axial and/or radial position for the window during changeover in the format being produced.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 a section through a blade roll with vacuum supply holes and vacuum ports in the lateral surface of the blade roll,

FIG. 2 a partial section of a roll body part of a blade roll with flex die cutter attached,

FIG. 3 a set of adapter plates in different configurations for defining different axial and radial positions of a flex die window cutter,

FIG. 4 a flex die window cutter attached by means of an adapter plate in a recess of a flex die shape cutter with pin cams,

FIG. 5 a two-piece flex die shape cutter with adapter plate attached to the pin strip of a magnetic cylinder including flex die cutter,

FIG. 6 a flex die shape cutter in a split design, with an adapter plate that is elongated in the circumferential direction, on which is accommodated a flex die window cutter,

FIG. 7 a flex die shape cutter with pin cams and with recess, in which a flex die cutter is attached by means of an adapter plate,

FIG. 8 a flex die shape cutter with recess with, inserted in the recess, a flex die window cutter which is held in position by a strip-shaped adapter plate supported on the trailing recess edge,

FIG. 9 a flex die shape cutter with two flex die window cutters placed in its recess, one of which is positioned in the pin strip of the magnetic cylinder and the other of which is positioned through a strip-shaped adapter plate in similar manner to FIG. 8,

FIG. 10 a flex die shape cutter with flex die window cutters set in different positions in a recess, and

FIG. 11 a flex die shape cutter with three flex die window cutters located in a recess, one of which is attached directly in the pin strip, another of which is secured in the recess by means of an adapter plate, and the third flex die window cutter is supported on a strip-shaped adapter plate on a recess.

### DETAILED DESCRIPTION

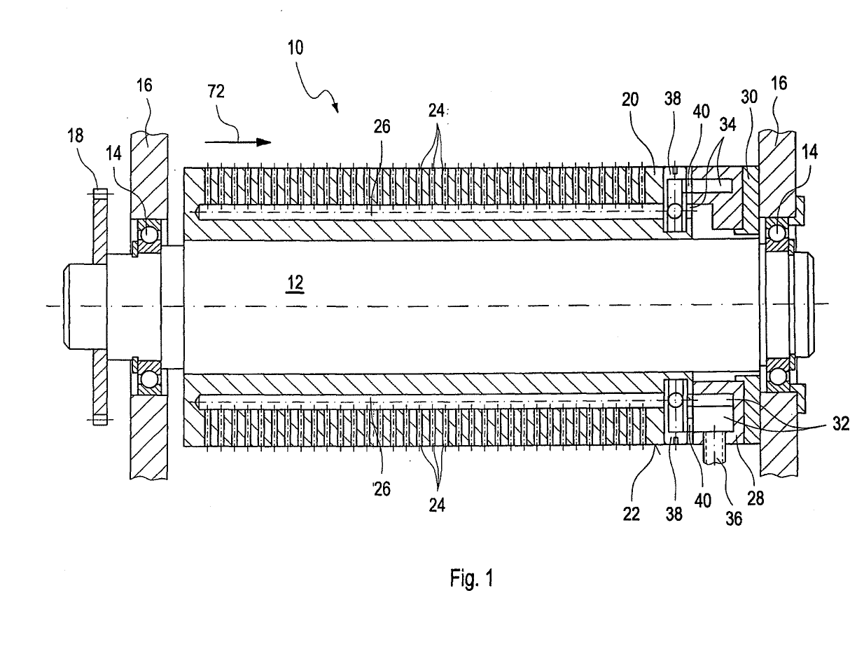

FIG. 1 shows a cross-sectional representation of the important parts of a blade roll and its support.

Visible in FIG. 1 is a blade roll 10, whose bearings 14 and important parts are shown in cross-section, but without a flex die cutter and without the parts needed to attach and align a flex die cutter.

The blade roll 10 includes a supporting shaft 12, which is mounted in machine frames 16 with the aid of bearings 14, and is driven by means of a gear 18 or directly by a servomotor. Supported on the supporting shaft 12 in a rotationally fixed manner between the machine frames 16 is a cylindrical roll body part 20, on whose lateral surface 22 are located suction ports 24 that are arranged next to one another in rows 74. In the roll body part 20, suction passages 26 are arranged parallel to the axis at a distance from an axis of rotation of the blade roll 10; these suction passages stand in air-conducting communication with the suction ports 24. Located on the end face of the roll body part 20 is a suction control valve 28, which is supported in a rotationally fixed manner on the frame wall 16 by means of a spacing and centering bushing 30. The suction control valve 28 has two separate, mutually concentric suction passages 32, which are followed by fresh air passages 34. The suction passages 32 are connected by a suction supply 36 to a suction source that is not shown. The suction passages can be subjected to suction starting from the suction passages 32 via an intake and transport angle region. A 3/3 directional control valve 38 is associated with the suction control valve 28 in each of the suction passages 26 in the roll body part 20. By means of the 3/3 directional control valve 38, a suction passage 26 can be blocked or connected to the suction control passages 32 through a through-hole 40. Each of the suction passages 32 is followed by a fresh air passage 34, whence a release of the vacuum takes place in the suction passages 26 and the suction ports 24 that are formed in the lateral surface 22 of the blade roll 10.

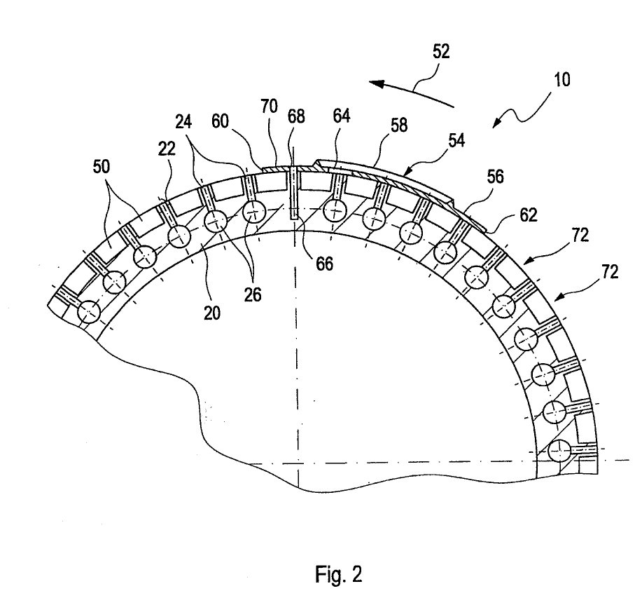

FIG. 2 shows the arrangement and attachment of a flex die cutter to the roll body part of a blade roll revolving in the direction of rotation.

A flex die shape cutter 54 is held magnetically on the lateral surface 22 of the blade roll 10 revolving in the direction of rotation 52. The flex die shape cutter 54 includes a base plate 56 of thin design. The base plate 56 of the flex die shape cutter 54 is preferably made of a magnetically permeable material with a small thickness. The base plate 56 of the flex die shape cutter 54 includes a front edge 60 and a back edge 62. Located on the base plate 56 of the flex die shape cutter 54 is at least one sharp cutting edge 58, designed as a single piece, which forms a specific cutting shape, thus, e.g., for producing an envelope, to name just one example.

Arranged in the flex die shape cutter 54 are apertures 64, which stand in air-conducting communication with the suction ports 24. The cross-sectional representation in FIG. 2 shows regions in the lateral surface 22 covered by the base plate 56 of the flex die shape cutter 54 that are not provided with apertures 64.

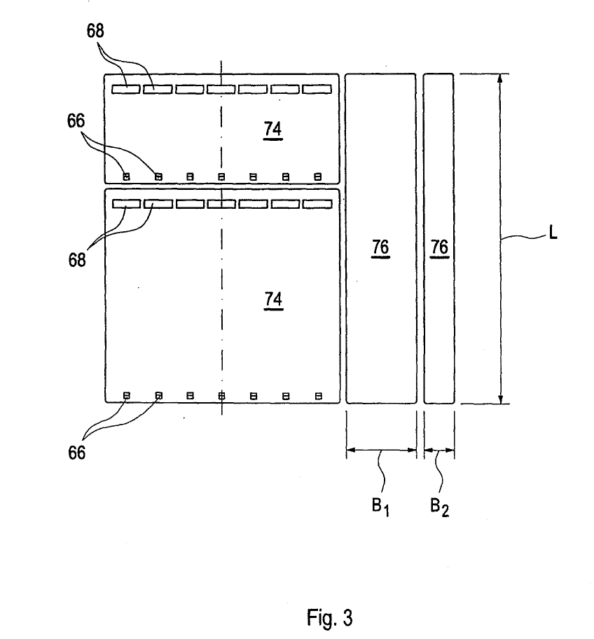

Viewed in the direction of rotation 52 of the blade roll 10, slotted openings 68 are made in the base plate 56 in a forward region 70 adjoining the front edge 60. The slotted openings 68 extend essentially in rows next to one another at a leading edge (cf. the representation in FIGS. 3-11), of, for example, flex die window cutters 78, as is described in greater detail below.

Located on the lateral surface 22 of the blade roll 10 is at least one row of positioning pins 66, which pins project radially out of the lateral surface 22 of the roll body part 20 to a certain height. This height corresponds approximately to the thickness of the base plate 56 of the flex die shape cutter 54 to be secured. The holding and positioning pins are likewise arranged in rows in circumferential segments on the lateral surface 22 of the blade roll 10.

Moreover, as shown in the cross-sectional view in FIG. 2, magnetic elements 50 are arranged in rows on the lateral surface 22 of the roll body part 20, with one of these rows alternating in each case with a row 74 of suction ports 24.

For accurately placed positioning and securing of a flex die shape cutter 54 on the lateral surface 22 of the roll body part 20, said cutter is attached to the holding and positioning pins 66—as shown in FIG. 2—so that the holding and positioning pins 66 project into the slotted openings 68 at the front edge 60 of the flex die shape cutter 54. During the attachment process, the flex die shape cutter 54 can be displaced to a limited extent in the x-direction, i.e. in the axial direction, within the region of a slot length of the slotted openings 68. Greater axial displacements can be achieved by repositioning the flex die shape cutter 54 in the row 74 of the holding and positioning pins 66. After the attachment process, the flex die shape cutter 54 is secured in an interlocking manner in the circumferential direction by means of the holding and positioning pins 66 engaging the slotted openings 68, and is secured in a force-locking manner on the lateral surface 22 of the blade roll 10 by means of the magnetic elements 50. Thus, even under difficult cutting conditions, shifting of the flex die shape cutter 54 on the lateral surface 22 of the blade roll 10 is not possible.

A set of adapter elements can be seen in the representation in FIG. 3.

As is evident from the representation in FIG. 3, a set of adapter elements according to this illustration includes, for example, an adapter element 74 in the shape of a square, at whose front edge are provided slotted openings 68 next to one another in a row for the attachment of attachment pins 66 (pin cams). At the trailing end, which is to say the back edge of the adapter element 74 according to the representation in FIG. 3, are located holding and positioning pins 66, likewise arranged next to one another in a row. In addition, the set of adapter elements 74, 76 as represented in FIG. 3 includes strip-shaped adapter elements 76. These are implemented with a length L and can be implemented with various widths B₁ or B₂.

The adapter elements 74 and 76 shown in FIG. 3 have in common that they are made of a magnetically permeable material and can, of course, also be implemented with different geometries than those shown in FIG. 3, which is to say other than rectangular, square, or strip-shaped.

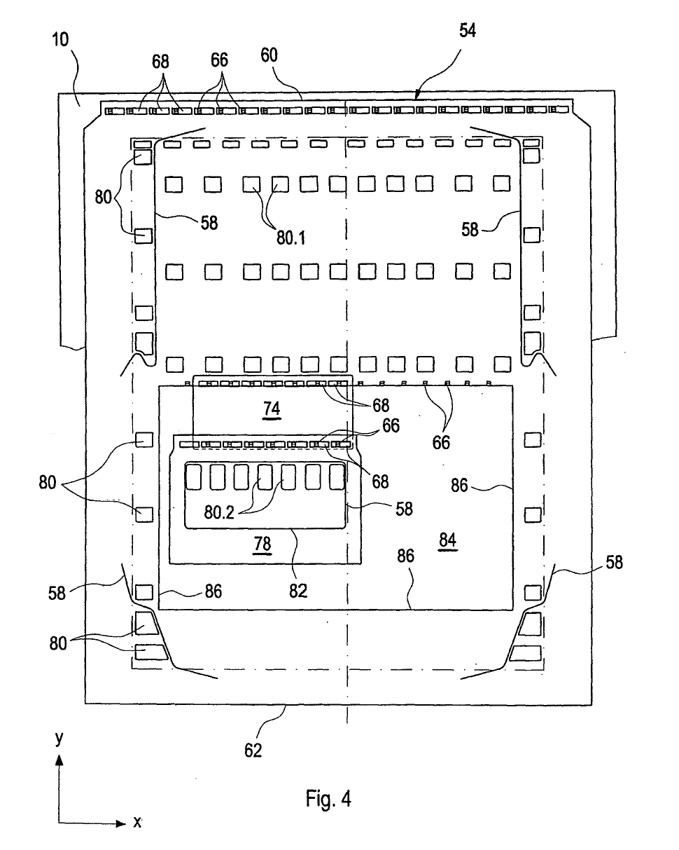

The principle of operation of the set of adapter elements shown by way of example in FIG. 3 is described in detail with reference to FIGS. 4 through 11, which will be described in greater detail below. In these FIGS. 4 through 11, the blade roll 10 from FIGS. 1 and 2 is merely indicated.

FIG. 4 shows by way of example a flex die shape cutter 54 formed as a single piece with a recess.

As is evident from the representation in FIG. 4, the recess 84 is delimited by a boundary 86. The flex die shape cutter 54 as shown in the top view in FIG. 4 is made in accordance with the curvature of the lateral surface 22 of the blade roll 10, and includes, in addition to the leading front edge 60, the back edge 62. The flex die shape cutter 54 as shown in the top view in FIG. 4 is implemented as a single piece. The aforementioned slotted openings 68, with which the flex die shape cutter is attached to holding and positioning pins 66 that are implemented in the lateral surface 22 of the blade roll 10, extend in the form of a row in the region of the front edge 60.

As FIG. 4 shows, the holding and positioning pins 66 are located in the boundary 86 that runs parallel to the front edge 60 of the flex die shape cutter 54. Attached in these is a rectangular adapter element 74, as shown in FIG. 4. At the leading edge of the rectangular adapter element 74, this element has the slotted openings 68, while the holding and positioning pins 66 in a row are implemented on the trailing end of the adapter element 74 as shown in FIG. 4. The slotted openings at the front edge of the flex die window cutter 78 are attached in these holding and positioning pins 66 on the trailing edge of the adapter element 74. Both the rectangular adapter element 74 and the flex die window cutter 78 are secured on the lateral surface 22 of the blade roll 10 by the magnets 50 shown in FIG. 2, which are arranged in a row next to one another on the lateral surface 22, and assisted by the rows of suction ports 24 that extend in alternation with the rows of magnetic elements 50 and to which vacuum is supplied. In this way it is ensured that both the adapter elements 74, the adapter element 74 as depicted in FIG. 4, and the flex die window cutter 78 positioned thereby, are held reliably and securely on the lateral surface 22 of the blade roll 10, and remain secured, even at relatively high rotational speeds.

FIG. 4 additionally shows that the flex die window cutter 78 can have a surrounding cutting edge 58, which delimits a window cutout 82. Formed along the boundary 86 of the recess 84 are suction ports 80. Both the cutting edge 58 of the flex die window cutter 78, and the cutting edge 58 of the flex die shape cutter 54, define on the one hand a shape cutting die outline of the envelope to be transported, and on the other hand of the window cutout 82 to be cut. Thus, the suction ports that secure the window scrap are identified by the reference number 80.2 on the window cutter within the cutting edge 58. With reference to the cutting edge 58, suction ports 80 are located outside the shape cutting die outline defined by the cutting edge 58 of the flex die shape cutter 54. The suction ports 80 outside the cutting edge 58 serve to transport lateral scrap strips, while suction ports 80.1 located inside the cutting edge 58 of the flex die shape cutter 54 serve to transport the envelopes to the blade roll 10.

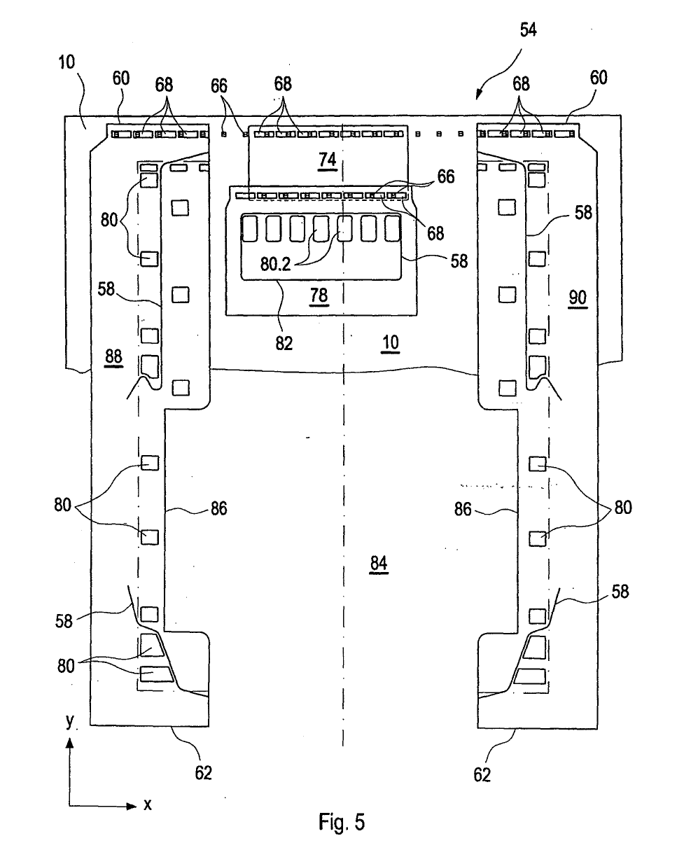

Visible in the depiction shown in FIG. 5 is a multi-piece flex die shape cutter, which includes a first blade part 88 and a second blade part 90. The boundaries 86 of the first blade part 88 and second blade part 90 that face one another delimit the recess 84. The cutting edges 58 located on the blade parts 88, 90, connected as a single piece to the base plate of the applicable blade parts 88, 90, each define a cutting shape, so that an envelope, for example a mailing envelope, can be cut out of a material in sheet form, such as a sheet of paper or cardboard, for example.

Each of the two blade parts 88 and 90 includes the front edge 60 with recesses 68 arranged next to one another in rows, as well as the back edge 62, which is designed without slotted recesses.

As is evident from the depiction in FIG. 5, the adapter element 74, with its slotted openings 68 implemented at the front edge and arranged in the form of rows, is attached in holding and positioning pins 66, which in this case are implemented on the lateral surface 22 of the blade roll 10.

Located in a row on the trailing edge of the adapter element 74 in the shape of a rectangle, which preferably is made of a magnetically permeable material, are holding and positioning pins 66. Attached to these, in turn, are the slotted openings 68 in the leading edge of the flex die window cutter 78. This cutter includes a surrounding cutting edge 58, which defines a recess identified by the reference symbol 82 that is made by the flex die window cutter 58 in, e.g., a mailing envelope, which is to say a window envelope.

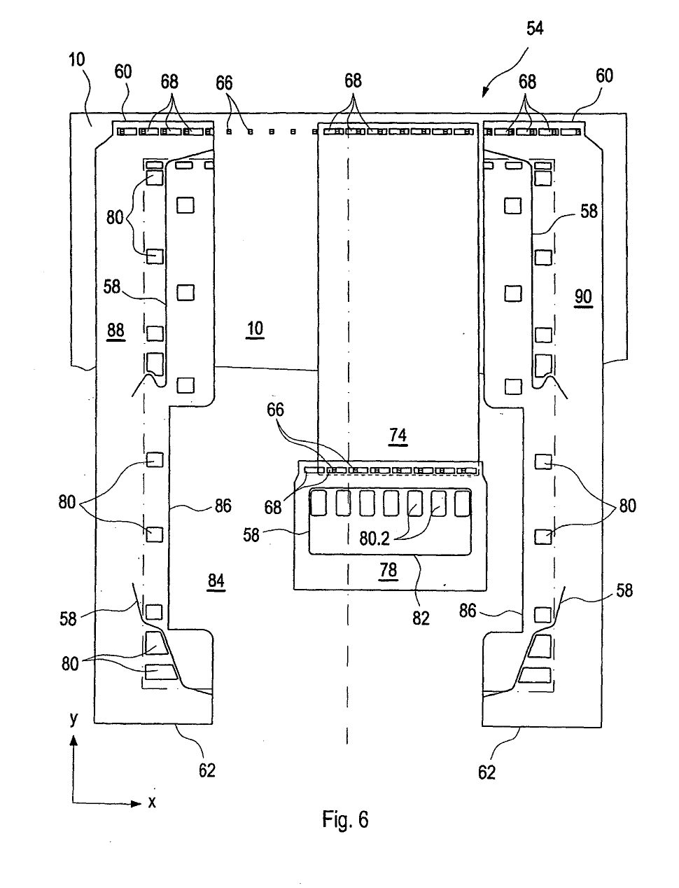

As an alternative to the depiction in FIG. 5, the adapter element 74 shown there, which extends a relatively short distance in the y-direction, can also be made longer, cf. in particular the example embodiment in FIG. 6.

The depiction in FIG. 6 likewise shows a two-piece flex die cutter. Similar to the depiction from FIG. 5, the flex die shape cutter 54 includes the first blade part 88 and the second blade part 90. Both blade parts 88 and 90 include a front edge 60 and back edge 62. Slotted openings 68 extend in both blade parts 88 and 90.

As is evident from the depiction in FIG. 6, an adapter element 74 that extends in the circumferential direction, which is to say in the y-direction, is accommodated. This adapter element has, on its leading edge, a number of slotted openings 68 located next to one another. These openings are attached to, for example, holding and positioning pins 66 on the lateral surface 22 of the blade roll 10. Located on the trailing end of the adapter element 74 that has a longer extent in the y-direction are a number of holding and positioning pins 66. Attached to these are slotted openings 68 of the front edge of the flex die window cutter 78. The x- or y-position of the flex die window cutter 78 with respect to the boundary 86 of the recess 84 between the first blade part 88 and the second blade part 90 of the window cutter 54 is determined as a function of the length, which is to say the extent in the y-direction (circumferential direction) of the adapter element 74.

The x-position of the flex die window cutter 78 can be achieved, for example, by moving and reattaching the flex die window cutter 78 on the holding and positioning pins 66 on the trailing end of the adapter element 74. Another positioning possibility for the flex die window cutter 78 is produced in that this securing adapter element 74 itself is moved and reattached in the x-direction to the holding and positioning pins 66 on the lateral surface 22 of the blade roll 10.

This is determined by the spacing of the boundaries 86 and the production requirements.

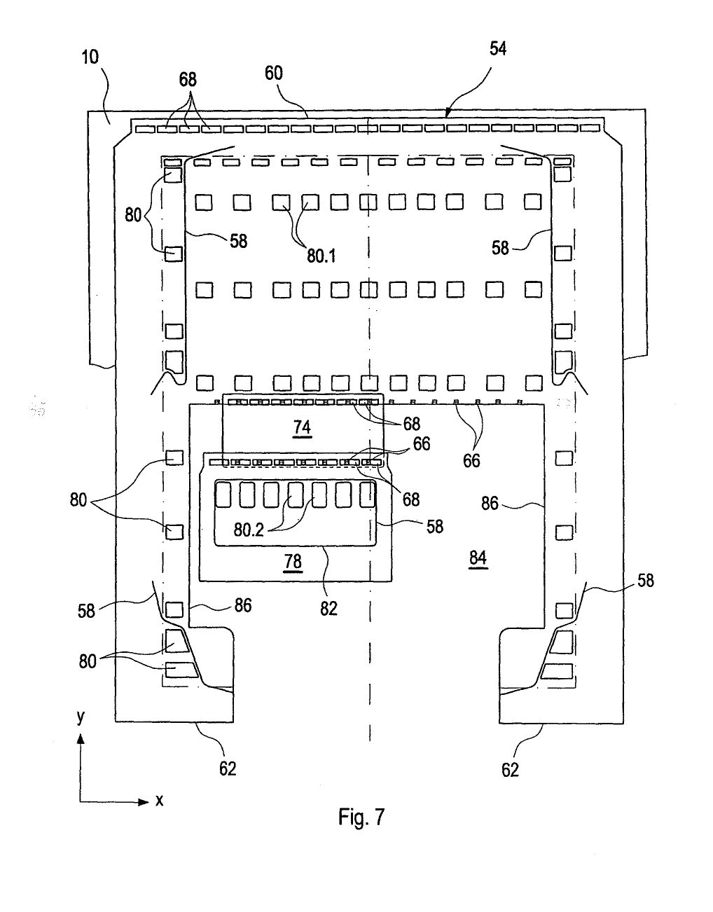

A single-piece window cutter 54 is visible in the depiction in FIG. 7. This, too, includes the front edge 60 and back edge 62. The recess 84 of the single-piece window cutter 54 is defined by the boundaries 86. As FIG. 7 shows, the flex die window cutter 78 is secured by the adapter element 74 within the recess 84. The adapter element 74 with its slotted openings 68 is attached to the holding and positioning pins 66, which are located on the boundary 86 of the recess 84 on the side that extends parallel to the front edge 60 and parallel to the two back edges 62. Attached to the trailing edge of the adapter element 74 is the flex die window cutter 78 with its slotted openings 68 in the holding and positioning pins 66. The flex die window cutter 78 depicted in FIG. 7 likewise shows a surrounding cutting edge 58, which delimits the recess 82, which is to say the window opening to be made in the sheet material, thus, for example, a mailing envelope window.

Reference numbers 80, 80.1 identify suction ports located in the single-piece flex die shape cutter 54. All suction ports 80.1 located within the cutting edge 58 of the flex die shape cutter 54 serve to transport the blank, which is to say the sheet from which the envelope contour is cut, while all suction ports 80 located outside the cutting edge 58 serve to transport scraps. The suction ports 80.2 located inside the window cutout 82 in FIG. 7 serve to transport the window scraps cut out of the window cutout 82.

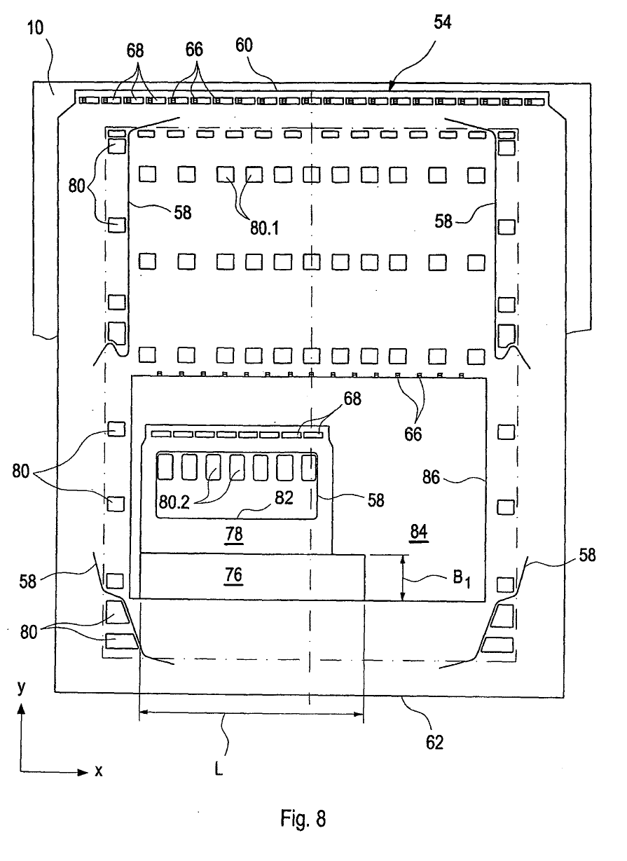

Evident in the depiction in FIG. 8 is a single-piece flex die shape cutter 54, which has a recess 84, inside of which a flex die window cutter 78 is positioned by means of a strip-shaped adapter element 76.

As FIG. 8 shows, in contrast to the exemplary embodiments described above with reference to FIGS. 4 through 7, the flex die window cutter 78 is not attached with holding and positioning pins 66 (pin cams), but instead is secured magnetically or by vacuum on the lateral surface 22 of the blade roll 10 as shown in FIGS. 1 and 2. The flex die window cutter 78 positioned in the recess 84 in FIG. 8 is positioned with respect to the boundary 86 extending parallel to the back edge 62 by the adapter strip 76. This adapter strip has a length L and a width B₁, cf. the depiction in FIG. 3.

Due to the action of the magnetic elements 50 embedded in the lateral surface 22 and the application of vacuum to the lateral surface 22 of the blade roll 10, both the adapter element 76 and the flex die window cutter 78 are fixed in place. In a manner analogous to the variant embodiments described above, this cutter has the surrounding cutting edge 58 which delimits the recess 82. The flex die window cutter 78 shown in FIG. 8 that is positioned by the adapter element 76 also has slotted openings 68 next to one another at its front edge. As a supplement to the securing by the application of vacuum to the lateral surface 22 and the securing by the magnetic elements 50 embedded in the lateral surface 22, the flex die window cutter 78 shown in FIG. 8 and positioned by the strip-shaped adapter element 76 could also be attached at its slotted openings 68 to the holding and positioning pins 76 through the use of an appropriately configured adapter element, cf. the above variant embodiments.

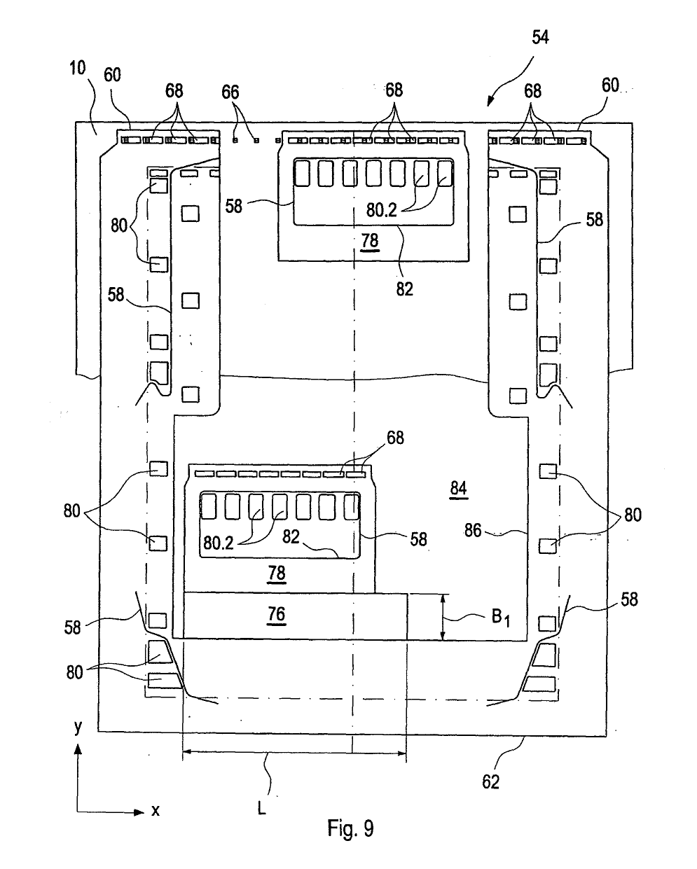

The depiction in FIG. 9 likewise shows a single-piece flex die shape cutter that has a divided front edge 60 and a back edge 62 of discontinuous design.

The single-piece flex die shape cutter 54 delimits the recess 84, which is framed on the sides by a boundary 86. In a manner analogous to the variant embodiment for FIG. 8 already outlined above, the adapter element 76 in the form of a strip is located inside the recess 84 at a section of the boundary 86 extending parallel to the back edge 62. The length of the strip-shaped adapter element 76 is labeled L, and its width is labeled B₁. The flex die window cutter 78 is secured with respect to the y-direction by this strip-shaped adapter element 76. Securing in the x-direction is accomplished by the action of the magnetic elements 50 embedded in the lateral surface 22 and by the application of vacuum to the lateral surface 22 of the blade roll 10.

Moreover, it is evident from the depiction in FIG. 9 that an additional flex die window cutter 78 is attached to holding and positioning pins 76 on the lateral surface 22 of the blade roll 10. The flex die window cutter 78 shown in FIG. 9 can be a flex die window cutter 78 previously described in conjunction with the variant embodiment shown in FIG. 4 through 8. Its displacement in the X-direction is accomplished simply by repositioning it on the holding and positioning pins 76. The flex die window cutter 78 is primarily secured by magnetic force; the application of vacuum to the lateral surface has a supporting effect.

In contrast to the exemplary embodiments described above with reference to FIGS. 4 through 8, multiple flex die window cutters 78—namely two thereof—are positioned in the exemplary embodiment from FIG. 9. These cutters are secured through the holding and positioning pins 66 (pin cams), magnetic force, and the application of vacuum to the blade roll 10, or through magnetic force and the application of vacuum to the blade roll 10.

Because of the variable positioning capability in both the y-direction (circumference) and the x-direction (axial direction) shown, windows in envelopes, to name just one example, can be produced in any desired positions.

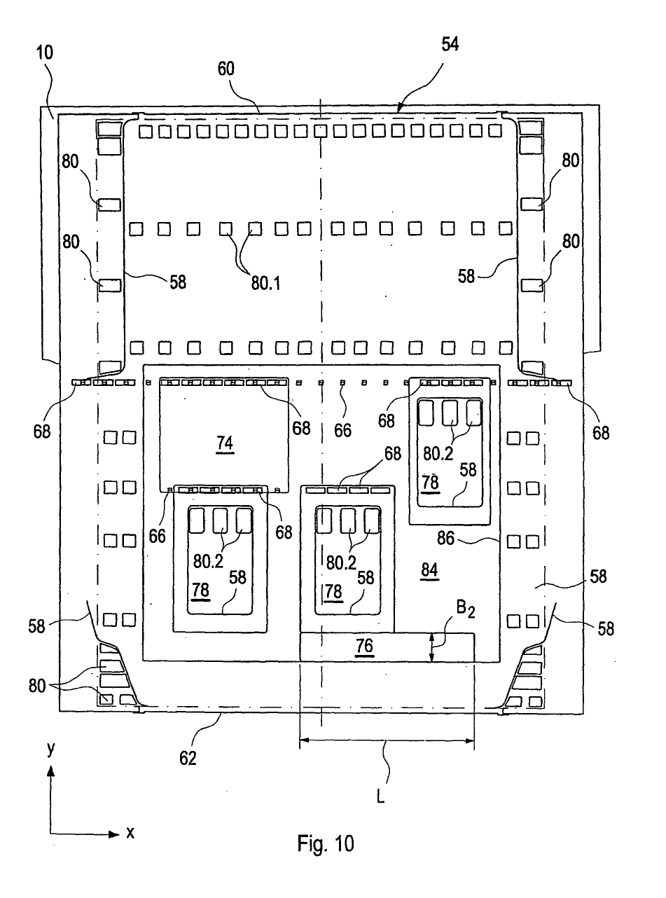

FIG. 10 shows another exemplary embodiment of a single-piece flex die shape cutter.

As FIG. 10 shows, the single-piece flex die shape cutter 54 includes the front edge 60 and the back edge 62. These extend continuously in the x-direction, which is to say in the axial direction with respect to the blade roll 10. Located in the single-piece flex die shape cutter 54 is a recess 84, which is delimited by the boundary 86. As is additionally evident from FIG. 10, a first (for example) of the three flex die window cutters 78 located in the recess 84 is fixed in place by the strip-shaped adapter element 76. This element is implemented with a length L and a width B₂, cf. the depiction in FIG. 3. The flex die window cutter 78 likewise includes at its leading end the slotted openings 68, which applies to all of the flex die window cutters 78 located in the recess 84. Another of the flex die window cutters 78 is attached by its slotted openings 68 to holding and positioning pins 66 at the trailing end of the adapter element 74. This element is attached to a pin strip of holding and positioning pins 66 at the circumference of the blade roll 10.

For reasons of identical part use, the three flex die window cutters 78 used in the recess 84 in FIG. 10 are identical and can be arranged at different positions with respect to the axial direction (y-coordinate) and the circumferential direction (x-coordinate) in the recess 84 of the single-piece flex die shape cutter 54 in the manner shown. In an analogous manner to the exemplary embodiments cited above, the three flex die window cutters 78 shown in the recess 84 in the exemplary embodiment from FIG. 10 are secured magnetically by the magnetic elements 50 embedded in the lateral surface 22 and also by the application of vacuum to the suction openings 24 in the lateral surface 22 of the blade roll 10 in accordance with the depictions in FIGS. 1 and 2.

The suction ports 80.1, which serve to transport the blank, are located inside the cutting edge 58, while the suction openings 80 located outside the cutting edge 58 of the flex die shape cutter 54 serve to transport the scraps produced during cutting.

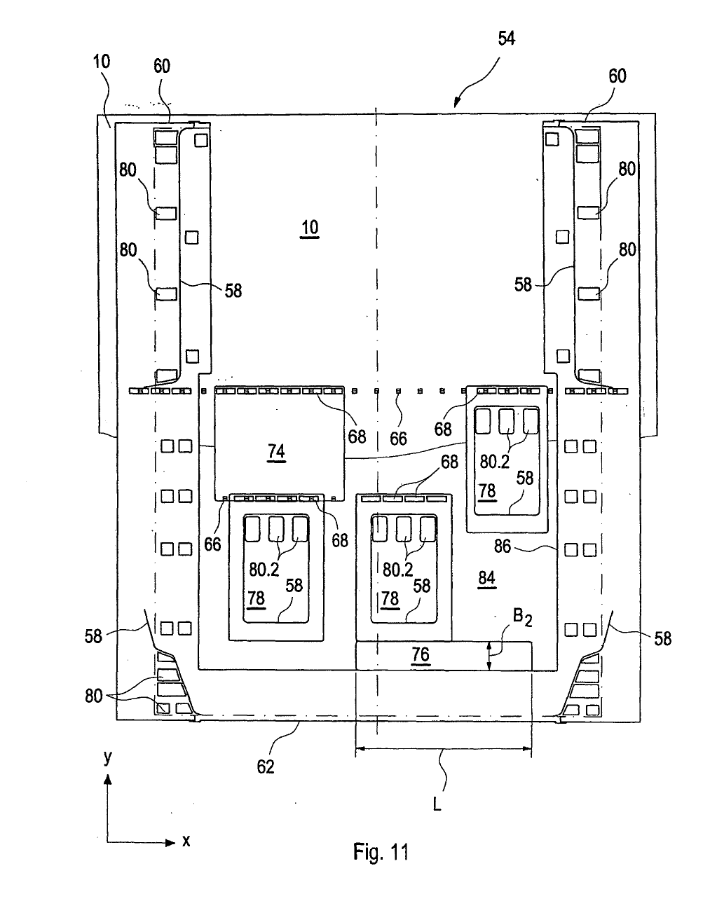

FIG. 11 shows a flex die shape cutter 54 whose front edge 64 is divided in design, and whose back edge 62 is continuous. In the single-piece flex die shape cutter 54, the recess 84 is delimited by the boundary 86.

Located in the bottom half of the recess 84 of the single-piece flex die shape cutter 54 are three flex die window cutters 78. One of the flex die window cutters 78 is positioned in the circumferential direction (y-direction) with the aid of the strip-shaped adapter element 76. The flex die window cutter or cutters 78 is/are secured in the x-direction by magnetic force, if applicable also by the application of vacuum to the lateral surface 22 of the blade roll 10.

A second flex die window cutter 78, likewise provided with a surrounding cutting edge 58, is attached by its slotted openings to the holding and positioning pins 66 on the trailing end of the adapter element 74. This element, in turn, has on its leading end slotted openings 68 arranged next to one another in the form of a row, which are attached to holding and positioning pins 66 that are not shown in FIG. 11. This additional flex die window cutter 78 is also fixed in place by attachment in a row of holding and positioning pins 66 formed in the lateral surface 22 of the blade roll 10, by the action of magnetic force of the magnetic elements 50, and additionally by the action of the vacuum.

Finally, a third flex die window cutter 78 is in turn fixed in place by attachment in a strip or row of holding and positioning pins 76 implemented in the lateral surface 22 of the blade roll 10, by the action of magnetic force, and additionally by the action of the vacuum on the lateral surface 22 of the blade roll 10.

The depiction shown in FIG. 11 also makes it clear that the single-piece flex die shape cutter 54 can accommodate at least three identical flex die window cutters 78. Of course, additional flex die window cutters 78 can also be accommodated in the top half of the recess 84 delimited by the boundary 86. Depending on the size of the recess 82, which must be produced in each case, larger or smaller flex die window cutters 78 may be used as shown in the above exemplary embodiments from FIGS. 4 through 11.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A flex die cutter arrangement for a blade roll, the arrangement comprising:
adapter elements; and
flex die window cutters and flex die shape cutters for producing window cutouts,
wherein the flex die window cutters are provided with a cutting edge,
wherein the flex die cutter arrangement and the flex die window cutters are attached magnetically or via vacuum to a lateral surface of the blade roll, and
wherein the flex die window cutters are configured to be variably positioned in axial and circumferential directions of the blade roll with respect to the flex die shape cutter by the adapter elements.

2. The flex die cutter arrangement according to claim 1, wherein the adapter elements are configured in a strip shape or in a rectangular shape.

3. The flex die cutter arrangement according to claim 1, wherein the adapter elements include cutting edges or slotted openings or holding and positioning pins.

4. The flex die cutter arrangement according to claim 1, wherein the flex die shape cutters are implemented as a single piece or as multiple pieces and include at least one recess that is delimited by boundaries.

5. The flex die cutter arrangement according to claim 4, wherein the recess is delimited by the boundary at which are located holding and positioning pins that engage in slotted openings of the adapter elements.

6. The flex die cutter arrangement according to claim 1, wherein the adapter elements are implemented as a set of adapter elements in different geometries and have slotted openings along an edge or a leading edge.

7. The flex die cutter arrangement according to claim 1, wherein the adapter elements are made of magnetically permeable material.

8. The flex die cutter arrangement according to claim 1, wherein the slotted openings extend along a leading edge of the adapter elements.

9. The flex die cutter arrangement according to claim 1, wherein, within the recess, the position of the flex die window cutters in the circumferential direction is defined by adapter elements braced against the boundary.

10. The flex die cutter arrangement according to claim 1, wherein, within the recess, the position of the flex die window cutters is defined in the circumferential direction by adapter elements, which are provided with slotted openings, which in turn are attached to holding and positioning pins.

11. The flex die cutter arrangement according to claim 1, wherein the flex die window cutters have a discontinuous or a surrounding cutting edge.
